(19) United States
(12) Patent Application Publication
(10) Pub. No.: US 2007/0194575 A1
(43) Pub. Date: Aug. 23, 2007

(54) Portable wind-driven electricity generation device

(76) Inventor: Kuang-Chieh Wu, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 11/356,067

(22) Filed: Feb. 17, 2006

(51) Int. Cl. F03D 9/00

(52) U.S. Cl. 290/55

(57) ABSTRACT

A portable wind-driven electricity generation device is provided herein, which mainly contains a fan, a generator assembly, a primary rechargeable battery, a secondary rechargeable battery, and an auxiliary driving assembly. When there is wind, the wind would drive the generator assembly to continuously charge the primary and secondary rechargeable batteries. The electricity supplied from the generation device is drawn from the primary rechargeable battery only. When there is no wind and when the primary rechargeable battery is not yet fully charged, a motor of the auxiliary driving assembly can be engaged from the stored electricity of the secondary rechargeable battery to drive the generator assembly so that the primary rechargeable battery can be as much charged as possible.

### BACKGROUND OF THE INVENTION

(a) Technical Field of the Invention

The present invention generally relates to electricity generation devices, and more particularly to a portable wind-driven electricity generation device.

(b) Description of the Prior Art

Portable consumer electronic devices such as cellular phone, PDA, MP3 player, digital camera are gaining widespread popularity in recent years. These portable devices are usually operated from a built-in rechargeable battery or from some replaceable batteries, so that their use is not confined to the proximity of wall outlets.

However, rechargeable batteries are usually quite limited in terms of their electrical capacity. Once their electricity is depleted, a wall outlet is not always conveniently available for recharging. Or, spare replaceable batteries have to be ready at hands for the unexpected shortage of power, which is quite troublesome.

Wind-driven generator is a well-known technology and has been widely applied as there is basically unlimited wind to harness and its usage presents no threat to the environment. However, the availability of wind is not human-controllable and therefore wind-driven generators are usually deployed at fixed and windy outdoor locations.

### SUMMARY OF THE INVENTION

The primary purpose of the present invention is to provide an energy-saving, wind-driven, portable electricity generation device.

To achieve the foregoing purpose, the present invention mainly contains a fan, a generator assembly, a primary rechargeable battery, a secondary rechargeable battery, and an auxiliary driving assembly. The generator assembly in turn contains a casing member, an axle, a magnet, and a coil. The fan is fixedly configured at an end of the axle. Under a blow of the wind, the axle is rotated along with the fan, causing the magnet attached to the axle to spin inside the coil which is arranged around the inner wall of the casing member. Due to electromagnetic induction, an electrical current is produced on the coil, which charges the primary and secondary rechargeable batteries electrically connected to the coil in parallel. The auxiliary driving assembly contains a motor electrically connected to the secondary rechargeable battery and a transmission member through which the motor drives the generator assembly.

When there is wind, the wind would drive the generator assembly to continuously charge the primary and secondary rechargeable batteries. The electricity supplied from the generation device is drawn from the primary rechargeable battery only. When there is no wind and when the primary rechargeable battery is not yet fully charged, the motor of the auxiliary driving assembly can be engaged from the electricity of the secondary rechargeable battery to drive the generator assembly so that the primary rechargeable battery can be as much charged as possible.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a wind-driven electricity generation device according to a first embodiment of the present invention.

FIG. 2 is a schematic diagram showing the relationship between the major components of FIG. 1.

FIG. 3 is a schematic diagram showing a wind-driven electricity generation device according to a second embodiment of the present invention.

FIG. 4 is a schematic diagram showing a wind-driven electricity generation device according to an embodiment of the present invention being carried by a user.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

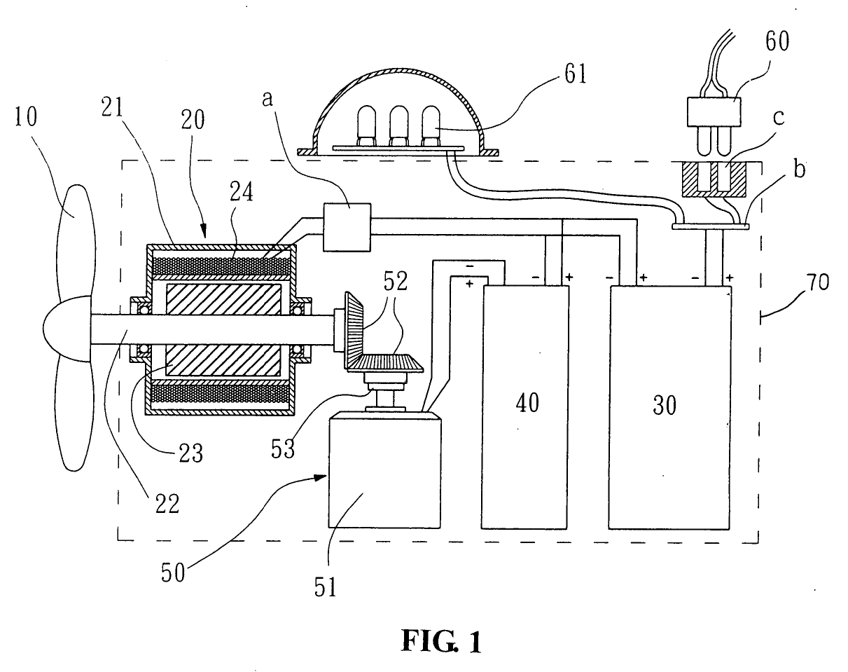

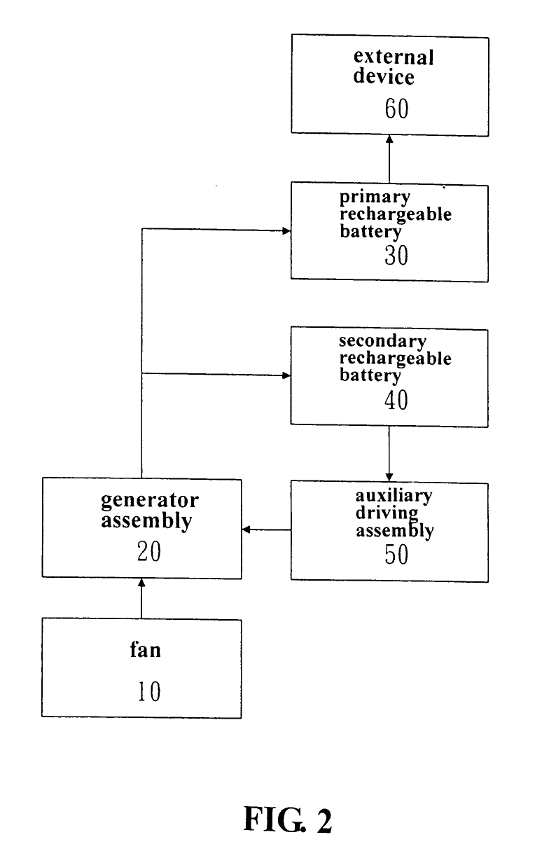

Please refer to FIGS. 1 and 2. As illustrated, a first embodiment of the present invention mainly contains a fan 10, a generator assembly 20, a primary rechargeable battery 30, a secondary rechargeable battery 40, and an auxiliary driving assembly 50.

The generator assembly 20, has a hollow cylindrical casing member 21. An axle 22 penetrates through the casing member 21 along the axial direction of the casing member 21. A magnet 23 is fixedly attached to a middle section of the axle 22 inside the casing member 21. The axle 22 is supported by bearings (not numbered) at the two ends of the casing member 21 so that the axle 22 along with the magnet 23 can freely spin by itself inside the casing member 21. A coil 24 is provided around the inner wall of the casing member 21 without interfering the spinning of the axle 22 and the magnet 23.

The fan 10 is fixedly attached to an end of the axle 22 outside the casing member 21. When a blow of wind drives the fan 10 to spin, the magnet 23 around the axle 22 is rotated as well, causing a relative motion between the coil 24 and the magnet 23. Due to the electromagnetic induction, an electrical current therefore is produced on the coil 24.

The produced electrical current charges the primary and secondary rechargeable batteries 30 and 40 which are electrically connected to the coil 24 in parallel via a rectifier (a).

The auxiliary driving assembly 50 contains at least a motor 51 and a transmission member 52 through which the motor 51 and the axle 22 interact. The motor 51 is electrically connected to the secondary rechargeable battery 40. The transmission member 52 can be a belt linking the axle 22 and the motor 51 or, as illustrated, it can be a pair of interacting bevel gears, one at the other end of the axle 22 opposite to the fan 10, and the other one at an end of the motor 51's axis. The bevel gear at the end of the motor 51's axis is installed via a one-way bearing 53. As such, the motor 51 can be engaged, from the electricity provided from the secondary rechargeable battery 40, to drive the generator assembly 20 via the bevel gears and, when the motor 51 is not engaged, it wouldn't interfere with the rotation of the axle 22 when the fan 10 is driven by wind.

When there is wind, the fan 10 is driven so that the generator assembly 20 continuously produces electricity to charge the primary and secondary rechargeable batteries 30 and 40 via the rectifier (a). An external device 60 electrically connected to the present embodiment is powered by the stored electricity of the main rechargeable battery 30 only. When there is no wind and when the primary rechargeable battery 30 is not yet fully charged, the auxiliary driving assembly 50 can be engaged, manually or automatically, from the stored electricity of the secondary rechargeable battery 40 to drive the generator assembly 20 so that the primary rechargeable battery 30 can be as much charged as possible

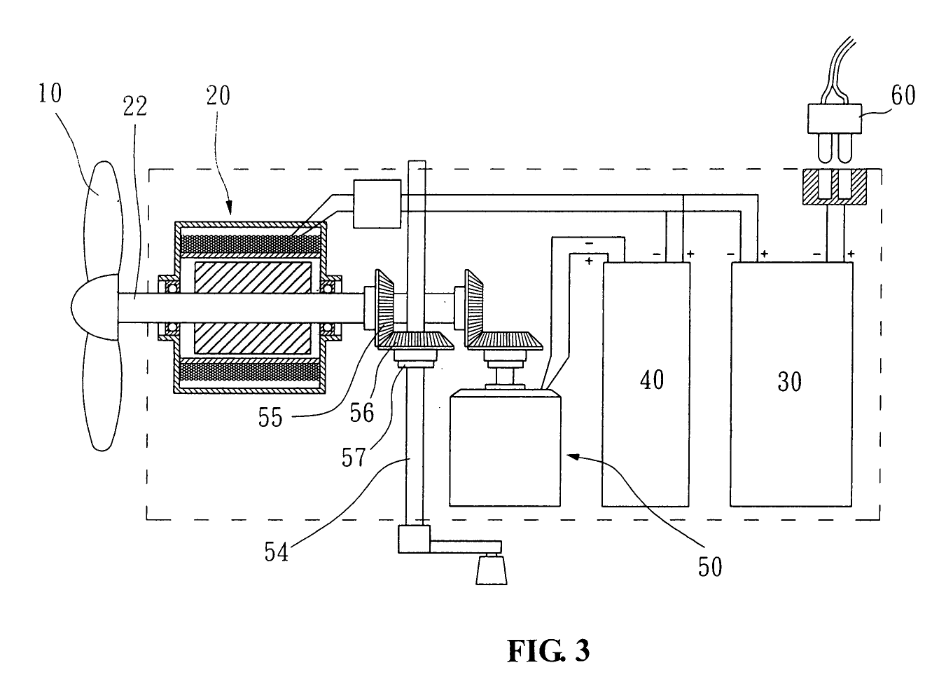

As shown in FIG. 3, a second embodiment of the present invention has an additional manual driving assembly. The manual driving assembly contains a handle bar 54 whose one end is configured with a bevel gear 56 via a one-way bearing 57. Another bevel gear 55 interacting with the bevel gear 56 is provided at an appropriate location along the axle 22 between the generator assembly 20 and the bevel gear 52. As such, when there is no wind and when both the primary and secondary rechargeable batteries 30 and 40 are under charged, the handle bar 54 can be rotated manually to drive the generator assembly 20 and charge the batteries 30 and 40. Similarly, because of the one-way bearing 57, the manual driving assembly wouldn't interfere with the rotation of the axle 22 when the fan 10 is driven by wind.

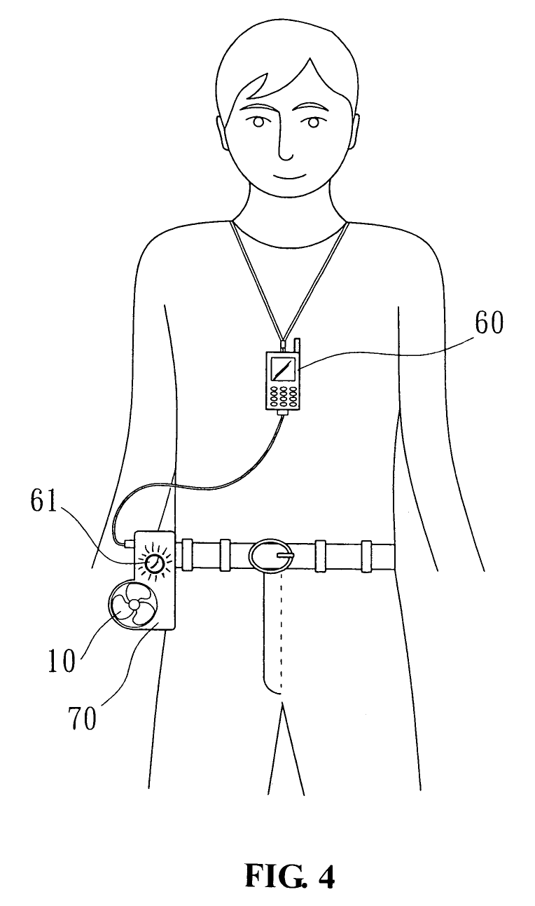

Please note that the foregoing components of the embodiments of the present invention are housed in an appropriate casing member 70 which exposes the fan 10 for wind driving, so that the embodiments can be conveniently positioned or carried as shown in FIG. 4. There are various implementations of the supply of electricity from the main rechargeable battery 30. As shown in FIG. 1, a regulator circuit (b) can be provided along the electrical path to the external device 60. A connector (c) can be provided on the surface of the casing member 70 to facilitate the connection to common consumer electronic devices such as cellular phone, PDA, MP3 player, digital camera, and electrical shave. Optionally, a lighting member 61 having a number of lamps can be built onto the casing member 70 and connected to the regulator circuit (b) so that the present invention can function as a lighting device as well.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wind-driven electricity generation device, comprising:
a generator assembly having a casing member, an axle penetrating through said casing member along the axial direction of said casing member, a magnet fixedly attached to a middle section of said axle inside said casing member, and a coil on the inner wall of said casing member;
a fan attached to an end of said axle;
an auxiliary driving assembly having a motor and an one-way transmission member linking the axis of said motor and the axle of said generator assembly so that said motor drives said axle but the spin of said axle is not interfered by said motor;
a primary rechargeable battery electrically connected to said coil and providing the stored electricity to at least an external device; and
a secondary rechargeable battery electrically connected to said coil and said motor of said auxiliary driving assembly;
wherein, when there is wind, the wind drives said fan which in turn causes a relative motion between said coil and said magnet to produce an electrical current on said coil to charge said primary and secondary rechargeable batteries; and, when there is no wind and when said primary rechargeable battery is not yet fully charged, said motor of said auxiliary driving assembly is engaged from the stored electricity of said secondary rechargeable battery to drive said generator assembly so that said primary rechargeable battery can be as much charged as possible.

2. The wind-driven electricity generation device according to claim 1, wherein said transmission member comprise a pair of interacting bevel gears in which a first one is provided on the other end of said axle opposite to said fan and a second one is provide on an end of said motor's axis by an one-way bearing.

3. The wind-driven electricity generation device according to claim 1, further comprising a manual driving assembly having a handle bar and a pair of interacting bevel gears in which a first one is provided on said axle outside said casing member of said generator assembly and a second one is provided on an end of said handle bar by an one-way bearing.
